(19) United States
(12) Patent Application Publication
(10) Pub. No.: US 2023/0186936 A1
(43) Pub. Date: Jun. 15, 2023

(54) METHOD FOR PROCESSING VOICE SIGNAL, AND APPARATUS USING SAME

(71) Applicant: SAMSUNG ELECTRONICS CO., LTD., Suwon-si (KR)

(72) Inventors: Jaemo YANG, Suwon-si (KR); Sangeun KIM, Suwon-si (KR); Soonho BAEK, Suwon-si (KR); Beakkwon SON, Suwon-si (KR); Gunwoo LEE, Suwon-si (KR); Hangil MOON, Suwon-si (KR); Yonghoon LEE, Suwon-si (KR)

(73) Assignee: SAMSUNG ELECTRONICS CO., LTD., Suwon-si (KR)

(21) Appl. No.: 18/105,046

(22) Filed: Feb. 2, 2023

Related U.S. Application Data
(63) Continuation of application No. PCT/KR21/09885, filed on Jul. 29, 2021.

(30) Foreign Application Priority Data
Aug. 4, 2020 (KR) 10-2020-0097147

(51) Int. Cl. G10L 21/0232; G10L 25/90; G10L 25/84

(52) U.S. Cl. CPC G10L 21/0232; G10L 25/90; G10L 25/84; G10L 2021/02166

(57) ABSTRACT

An audio apparatus includes: a sensor; a plurality of microphones; and at least one processor configured to: obtain a speech presence probability from a sensor signal obtained using the sensor; and cancel, using the obtained speech presence probability, noise from a speech signal received from at least one of the plurality of microphones.

### CROSS-REFERENCE TO RELATED APPLICATIONS

This application is a bypass continuation application of International Patent Application No. PCT/KR2021/009885, filed on Jul. 29, 2021, which is based on and claims priority to Korean Patent Application No. 10-2020-0097147, filed on Aug. 4, 2020, in the Korean Intellectual Property Office, the disclosures of which are incorporated by reference herein in their entireties.

### BACKGROUND

### 1. Field

The disclosure relates to a method of processing a speech signal and an apparatus using the same, and more particularly to the detection and cancellation of ambient noise in the speech signal, including speech of a counterpart rather than of a user of the apparatus.

### 2. Description of Related Art

Electronic devices such as earphones include speakers and microphones, and may be capable of outputting music or other sound and capable of obtaining speech signals. Recently, earphones that include a microphone, a communication module, and a processor, in addition to a speaker, have been developed. Such earphones include a speaker and may be capable of outputting a speech signal, and include a microphone and may be capable of receiving/obtaining speech signals. In addition, such earphones may be capable of transmitting a received speech signal to an electronic device or receiving a speech signal from an electronic device using a communication module.

As various applications that use earphones have been developed, interest in the functions and performances of the earphones and related requirements have been increased. As an application that needs to receive speech via earphones may include a call application, a speech recognition application, and a voice recording application.

When a speech input device such as a microphone is disposed far from the mouth of a user, it is difficult to capture the speech of the user. For example, the magnitude of ambient noise received by the speech input device may be higher than that of the speech of the user.

Additionally, when a speaker and a microphone are included in a single electronic device, such as earphones, and are disposed in a short distance from each other, it is difficult to distinguish between the speech of a user and the speech of a counterpart output from the speaker. If the speech of the counterpart output from the speaker is not distinguished, the speech may be input to the microphone and may be transferred back to the counterpart.

### SUMMARY

According to an aspect of the disclosure, an audio device includes: a sensor; a plurality of microphones; and at least one processor configured to: obtain a speech presence probability from a sensor signal obtained using the sensor; and cancel, using the obtained speech presence probability, noise from a speech signal received from at least one of the plurality of microphones.

The speech presence probability may be expressed as a ratio of speech signal to noise.

The sensor may be configured to detect signals corresponding to vibration of vocal cords caused by speech of a user.

The at least one processor may be further configured to, based on the sensor signal having a predetermined or higher intensity in a frequency band less than or equal to a predetermined frequency, determine the obtained speech presence probability as indicating a probability of the speech signal including speech of a user.

The at least one processor may be further configured to cancel noise from the speech signal by determining the speech presence probability with respect to an extended frequency band in which speech is expected to be present.

The at least one processor may be further configured to cancel noise from the speech signal by extending, based on a pitch of the speech signal, a frequency band in which speech is expected to be present, and determining the speech presence probability with respect to the extended frequency band.

The at least one processor may be further configured to, based on the sensor signal having a predetermined or higher intensity in a frequency band exceeding a predetermined frequency, determine the obtained speech presence probability as indicating a probability of the speech signal including speech of a counterpart.

The at least one processor may be further configured to, based on the sensor signal having both a predetermined or higher intensity in a frequency band less than or equal to a predetermined frequency and a predetermined or higher intensity in a frequency band exceeding the predetermined frequency, determine that double-talk occurs.

The sensor may include at least one of an acceleration sensor and a vibration sensor.

The audio device may further include a communication module, and the speech signal may be transmitted to an external electronic device by the communication module after cancellation of the noise therefrom.

According to an aspect of the disclosure, a method of operating an audio device, includes: obtaining a speech presence probability from a sensor signal received using a sensor module; and cancelling, using the obtained speech presence probability, noise from a speech signal received from at least one of a plurality of microphones.

The speech presence probability may be expressed as a ratio of speech signal to noise.

The sensor signal may correspond to vibration of vocal cords caused by speech of a user.

The method may further include determining the obtained speech presence probability as indicating a probability of the speech signal including speech of a user, based on the sensor signal having a predetermined or higher intensity in a frequency band less than or equal to a predetermined frequency.

The cancelling of the noise may include determining the speech presence probability with respect to an extended frequency band in which speech is expected to be present.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment according to various embodiments;

FIG. 2 is a block diagram illustrating an audio module according to various embodiments;

FIG. 3 is a block diagram illustrating an audio input/output device according to various embodiments;

FIGS. 4A, 4B, and 4C are diagrams illustrating an example of extending an effective frequency band of speech according to various embodiments;

FIGS. 5A, 5B, and 5C are diagrams illustrating an example of a speech signal extracted using a speech presence probability according to various embodiments;

FIG. 6 is a diagram illustrating an example of a signal received via a microphone according to various embodiments;

FIG. 7 is a diagram illustrating energy of a signal measured by an acceleration sensor for each of a plurality of frequency bands according to various embodiments;

FIG. 8 presents diagrams illustrating a result obtained by measuring and processing a signal in an echo environment according to various embodiments; and

FIG. 9 is a flowchart illustrating a method for processing a speech signal by an audio input/output device according to various embodiments.

### DETAILED DESCRIPTION

Hereinafter, various embodiments of the disclosure will be described with reference to the accompanying drawings.

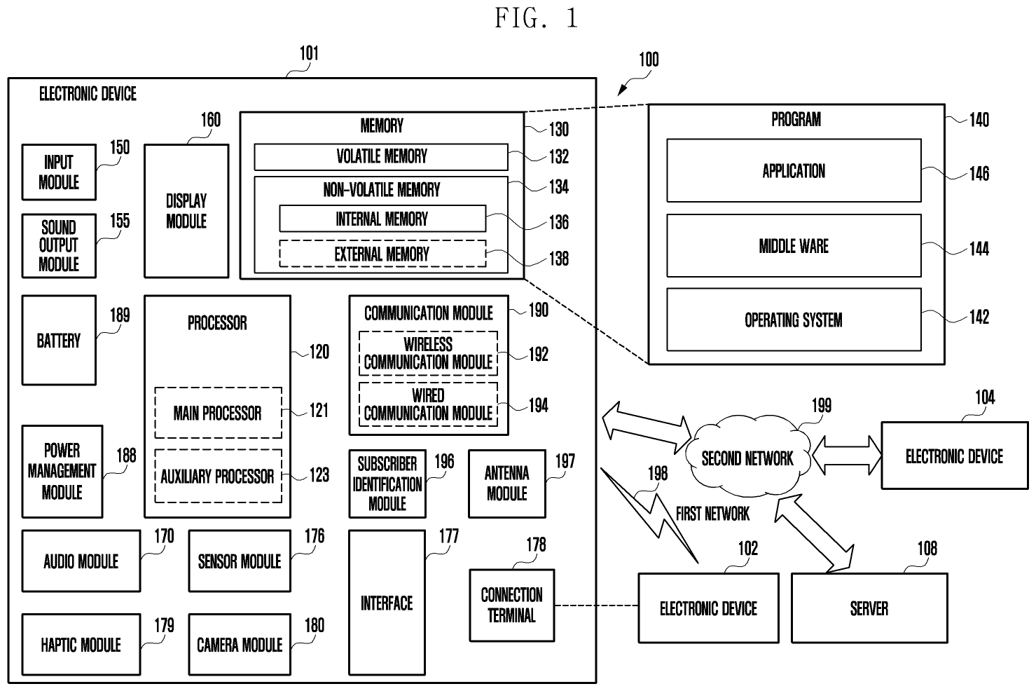

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In some embodiments, at least one of the components (e.g., the connection terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connection terminal 178 may include a connector via which the electronic device 101 may be physically connected with the external electronic device (e.g., the electronic device 102). According to an embodiment, the connection terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

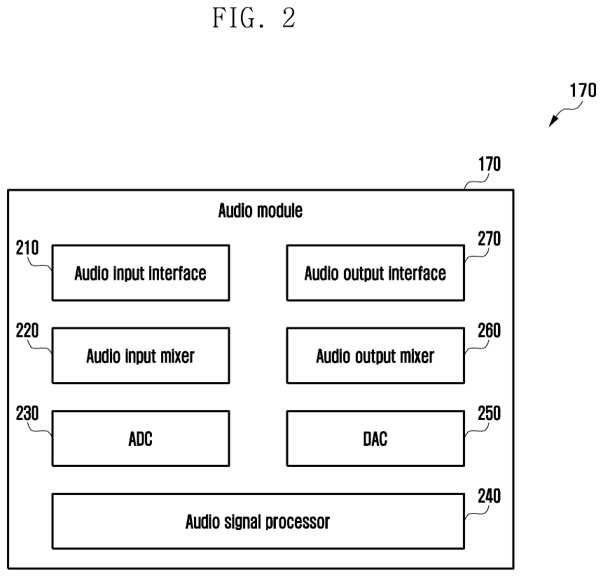

FIG. 2 is a block diagram 200 of the audio module 170 according to various embodiments. Referring to FIG. 2, the audio module 170 may include, for example, an audio input interface 210, an audio input mixer 220, an analog to digital converter (ADC) 230, an audio signal processor 240, a digital to analog converter (DAC) 250, an audio output mixer 260, or an audio output interface 270.

The audio input interface 210 may receive an audio signal corresponding to sound obtained from the outside of the electronic device 101 via a microphone (e.g., a dynamic microphone, a condenser microphone, or a piezo microphone) configured as a part of the input module 150 or configured separately from the electronic device 101. For example, when an audio signal is obtained from the external electronic device 102 (e.g., a headset or a microphone), the audio input interface 210 may receive an audio signal that is connected to the external electronic device 102 directly via the connection terminal 178 or connected via the wireless communication module 192 in a wireless manner (e.g., Bluetooth communication). According to an embodiment, the audio input interface 210 may receive a control signal (e.g., a volume control signal received via an input button) related to an audio signal obtained from the external electronic device 102. The audio input interface 210 may include a plurality of audio input channels, and may receive an audio signal different for each corresponding audio input channel among the plurality of audio input channels. According to an embodiment, additionally or alternatively, the audio input interface 210 may receive an audio signal from other component elements (e.g., the processor 120 or the memory 130) of the electronic device 101.

The audio input mixer 220 may combine a plurality of input audio signals into at least one audio signal. For example, according to an embodiment, the audio input mixer 220 may combine a plurality of analog audio signals input via the audio input interface 210 into at least one analog audio signal.

The ADC 230 may convert an analog audio signal into a digital audio signal. For example, according to an embodiment, the ADC 230 may convert, into a digital audio signal, an analog audio signal received via the audio input interface 210 or, additionally or alternatively, an analog audio signal combined by the audio input mixer 220.

The audio signal processor 240 may perform various processing with respect to a digital audio signal input via the ADC 230 or a digital audio signal received from other component elements of the electronic device 101. For example, according to an embodiment, the audio signal processor 240 may perform changing of a sampling ratio, applying of one or more filters, processing of interpolation, amplifying or attenuating of the entire or a part of a frequency band, processing of noise (e.g., attenuating noise or echo), changing of a channel (e.g., converting between mono and stereo), combining (mixing), or extracting of a designated signal with respect to one or more digital audio signals. According to an embodiment, one or more functions of the audio signal processor 240 may be embodied in the form of an equalizer.

The DAC 250 may convert a digital audio signal into an analog audio signal. For example, according to an embodiment, the DAC 250 may convert, into an analog audio signal, a digital audio signal processed by the audio signal processor 240 or a digital audio signal obtained from other component elements (e.g., the processor 120 or the memory 130) of the electronic device 101.

The audio output mixer 260 may combine a plurality of audio signals to be output into at least one audio signal. For example, according to an embodiment, the audio output mixer 260 may combine, into at least one analog audio signal, an audio signal converted into an analog signal via the DAC 250 and another analog audio signal (e.g., an analog audio signal received via the audio input interface 210).

The audio output interface 270 may output, to the outside of the electronic device 101 via the sound output module 155, an analog audio signal obtained via conversion by the DAC 250 or, additionally or alternatively, an analog audio signal obtained via combination by the audio output mixer 260. The sound output module 155 may include, for example, a speaker or a receiver such as a dynamic driver or balanced armature driver. According to an embodiment, the sound output module 155 may include a plurality of speakers. In this instance, the audio output interface 270 may output audio signals having a plurality of different channels (e.g., stereo or 5.1 channel) via at least some of the plurality of speakers. According to an embodiment, the audio output interface 270 may be connected to the external electronic device 102 (e.g., an external speaker or headset) directly via the connection terminal 178 or connected via the wireless communication module 192 in a wireless manner, and may output an audio signal.

According to an embodiment, the audio module 170 may produce at least one digital audio signal by combining a plurality of digital audio signals using at least one function of the audio signal processor 240, without separately including the audio input mixer 220 or the audio output mixer 260.

According to an embodiment, the audio module 170 may include an audio amplifier (not illustrated) (e.g., a speaker amplification circuit) capable of amplifying an analog audio signal input via the audio input interface 210 or an audio signal to be output via the audio output interface 270. According to an embodiment, the audio amplifier may be configured as a module separate from the audio module 170.

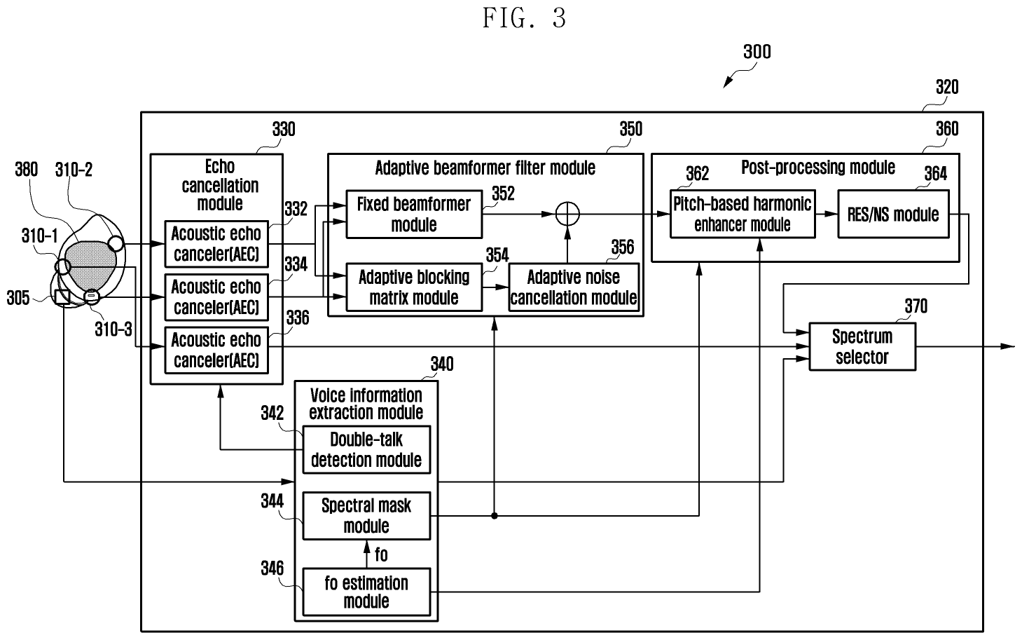

FIG. 3 is a block diagram illustrating an audio input/output device according to various embodiments.

According to various embodiments, an audio input/output device 300 may be embodied in the form of earphones. The audio input/output device 300 may be connected to the electronic device 101 of FIG. 1 in a wired manner or in a wireless manner. The audio input/output device 300 may further include a part of the configuration of the audio module 170 of FIG. 2.

According to various embodiments, the audio input/output device 300 may include a sensor or sensor module 305, microphones 310-1, 310-2, and 310-3, a processor 320, and a speaker 380.

According to various embodiments, the sensor module 305 may include an acceleration sensor and/or a vibration sensor. When a user speaks, the sensor module 305 may detect the vibration of vocal cords via bones and skin of the user. The frequency of a speech signal input through the sensor module 305 may be approximately 0 to 1 kHz. If a speech signal of a counterpart is output from a speaker, the signal may be a signal in a 6 kHz band. The sensor module 305 may be configured to detect a speech signal of a counterpart output from the speaker, in addition to a speech signal of the user. The sensor module 305 may be configured to detect, for example, a signal in a band ranging from 0 to 6 kHz.

According to various embodiments, a plurality of microphones 310-1, 310-2, and 310-3 may be configured. For example, two microphones 310-2 and 310-3 may be disposed in the outer side of the audio input/output device 300, and one microphone 310-1 may be disposed in the inner side of the audio input/output device 300. The number of microphones may be greater than or equal to, or may be less than the above example. In addition, the location of a microphone is not limited thereto.

According to various embodiments, the processor 320 may include an echo cancellation module 330, a voice information extraction module 340, an adaptive beamformer filter module 350, a post-processing module 360, and a spectrum selector 370.

According to various embodiments, the echo cancellation module 330 may include acoustic echo cancelers (acoustic echo canceler (AEC)) 332, 334, and 336. The echo cancellation module 330 may include a plurality of acoustic echo cancellers 332, 334, and 336. According to various embodiments, the plurality of acoustic echo cancellers 332, 334, and 336 may be connected to microphones 310-1, 310-2, and 310-3, respectively. The acoustic echo cancellers 332, 334, and 336 may be, for example, modules that perform processing so as to prevent speech of a user from being heard again via the microphones 310-1, 310-2, and 310-3 in a bidirectional communication device.

According to various embodiments, the voice information extraction module 340 may include a double talk (DT) detection module 342, a spectral mask module 344, and a fundamental frequency (f0) estimation module 346.

According to various embodiments, the double-talk detection module 342 may receive an output signal of the sensor module 305 and may detect whether a user and a counterpart simultaneously talk. The double-talk detection module 342 may detect whether double-talk occurs and may transfer the same to the echo cancellation module 330 using, for example, a flag.

According to various embodiments, the double-talk detection module 342 may receive an output signal of the sensor module 305, may divide a frequency band to compare energies between the divided frequency bands, and may detect whether double-talk occurs. Double-talk may be detected using, for example, a cross correlation between a far-end signal and a microphone input signal. However, in this instance, the performance of double-talk detection may be significantly decreased due to ambient noise around the user.

According to various embodiments, a user speech input via the sensor module 305 may be a signal corresponding to the vibration of vocal cords transferred via bones and/or skin, which may be a low frequency band signal in a frequency band of 700 Hz or less. Conversely, the speaker 380 of the audio input/output device 300 is incapable of reproducing a low band signal and thus, an echo signal may be a signal having relatively significantly low energy in a frequency band of 700 Hz or less. The echo signal may be a signal in a high frequency band compared to a speech signal of a user. The double-talk detection module 342 may easily distinguish echo and speech of a user using the energies of a low frequency band signal and a high frequency band signal. For example, the double-talk detection module 342 may determine that a user speech signal is received if the energy of a low frequency band signal is higher than a threshold value, and may determine that an echo signal is received if the energy of a high frequency band signal is higher than the threshold value. The double-talk detection module 342 may detect that double-talk occurs if both the energy of a low frequency band signal and the energy of a high frequency band signal are higher than the threshold value. The threshold value may be a predetermined value indicating a level of energy intensity. According to various embodiments, the acceleration sensor of the sensor module 305 is robust against ambient noise and may detect double-talk even in a noisy environment.

According to various embodiments, the double-talk detection module 342 may increase the accuracy of wake-up while a user is listening to music, and may operate in an always-on mode since the amount of operation performed is low. According to various embodiment, the double-talk detection module 342 may also be applied to the inner side (in-ear) microphone 310-1.

According to various embodiments, the spectral mask module 344 may detect a speech signal and speech harmonic using an output signal of the sensor module 305. The spectral mask module 344 may obtain a speech presence probability (SPP) using an output signal of the sensor module 305. According to various embodiments, the speech presence probability (SPP(f)) may be expressed as a ratio of an input signal to noise (signal-to-noise ratio (SNR)) for each frequency. According to various embodiments, a decision-directed scheme may be used for estimating the ratio of an input signal to noise for each frequency. The speech presence probability (SPP(f)) may be the probability of presence of speech in a speech signal band raging 0 to 1 kHz among signals received via the sensor module 305. The speech presence probability (SPP(f)) may be expressed by [Equation 1] below.

$$SPP ( f ) = P ( {H}_{1} \vert y ) = {( 1 + \frac{P ( {H}_{0} )}{P ( {H}_{1} )} ( 1 + {ζ}_{{H}_{1}} ) {e}^{\frac{{\vert y \vert}^{2}}{{{σ}_{N}}^{2}} \frac{{ζ}_{{H}_{1}}}{1 + {ζ}_{{H}_{1}}}} )}^{- 1} \qquad [ Equation 1 ]$$

Here, P(H₁) denotes a speech presence probability, P(H₀) denotes a speech absence probability, ζ denotes a priori SNR, and σ_{N}² denotes spectral noise power.

According to various embodiments, the spectral mask module 344 may store obtained information in a memory (not illustrated). The adaptive beamformer filter module 350 and the post-processing module 360 may read information stored in the memory when needed.

According to various embodiments, the f₀ estimation module 346 may predict a fundamental frequency (f₀) using the pitch of speech of a user. For example, the fundamental frequency (f₀) may be predicted as 1/the pitch of speech. According to various embodiments, the f₀ estimation module 346 may extend the effective frequency band (e.g., ˜2 kHz, ˜4 kHz, or the like) of the sensor module 305 using a fundamental frequency (f₀). When the effective frequency band of the sensor module 305 is extended, a speech presence probability may be determined based on the extended effective frequency band. This extended speech presence probability may be denoted by SPPe(f). According to various embodiments, the f₀ estimation module 346 may transmit the fundamental frequency (f₀) to the spectral mask module 344.

According to various embodiments, an adaptive beamformer filter module 350 may include a fixed beamformer module 352, an adaptive blocking matrix module 354, and an adaptive noise cancellation module 356. The adaptive beamformer filter module 350 may perform beamforming using speech information using the sensor module 305. According to various embodiments, the adaptive beamformer filter module 350 may be a generalized side-lobe canceller (GSC) beamformer.

According to various embodiments, the fixed beamformer module 352 may form a beam using a fixed minimum variance distortionless response (MVDR) filter. The MVDR filter may minimize a noise signal and an interference signal in a different direction, without distortion of a target signal in a directed direction. According to various embodiments, the MVDR filter may minimize beam output by designing a weight vector that restricts a signal other than a target signal. In order to obtain the MVDR filter, a covariance matrix with respect to a speech signal and a noise signal may be estimated. By using the predicted speech presence probability as a weight value for a current input signal when estimating the covariance matrix of a speech signal, a covariance matrix may be more accurately predicted in a noisy environment. In the same manner, a covariance matrix with respect to noise may be predicted. The covariance matrix with respect to noise may be predicted using a speech absence probability (SAP), and the speech absence probability (SAP) may satisfy a relationship of (1-speech presence probability). The covariance matrix with respect to a speech signal and a noise signal may be expressed by an equation as shown in Equation 2.

$$Cov\_speech \_mtx ( f ) = E \{ SPPe ( f ) X ( f ) {X}^{H} ( f ) \} = E \{ ( SPPe ( f ) [ \begin{matrix}{X}_{1} {X}_{1} & {X}_{1} {X}_{2}^{′} \\ {X}_{2} {X}_{1}^{′} & {X}_{2} {X}_{2}\end{matrix} ] \} Cov\_noise \_mtx ( f ) = E \{ ( 1 - SPPe ( f ) ) X ( f ) {X}^{H} ( f ) \} = E \{ ( 1 - SPPe ( f ) ) [ \begin{matrix}{X}_{1} {X}_{1} & {X}_{1} {X}_{2}^{′} \\ {X}_{2} {X}_{1}^{′} & {X}_{2} {X}_{2}\end{matrix} ] \} \qquad [ Equation 2 ]$$

Here, X(f) is an input signal, and may be expressed as a 2×1 vector of [X₁(f), X₂(f)].

According to various embodiments, an adaptive blocking matrix module 354 may be a generalized eigenvector blocking matrix (GEBM). The adaptive blocking matrix module 354 may perform a normalized least mean squares adaptive filter (NLMS ADF) using SPPe(f) as a step size. The adaptive blocking matrix module 354 may remove a speech leakage.

According to various embodiments, the adaptive noise cancellation module 356 may perform a NLMS ADF using (1-SPPe(f)) as a step size. The adaptive noise cancellation module 356 may cancel residual noise.

According to various embodiments, the post-processing module 360 may include a pitch-based harmonic enhancer module 362 and a residual echo suppression/noise suppression (RES/NS) module 364. The post-processing module 360 may convert an output signal of the adaptive beamformer filter module 350 into a cepstral domain, and may perform smoothing processing on the signal excluding a f₀ component. The post-processing module 360 may function as noise suppression (NS) that performs smoothing processing after excluding a f₀ component from an output signal of the adaptive beamformer filter module 350 so that a harmonic component of a user speech signal is maintained and other noise signals may be reduced via smoothing processing. The f₀ component may be obtained via the sensor module 305.

According to various embodiments, the spectrum selector 370 may compare an output signal of the adaptive beamformer filter module 350 and an output signal of the inner side (in-ear) microphone 310-1 at the location of a speech harmonic, and may output a higher signal between the two signals.

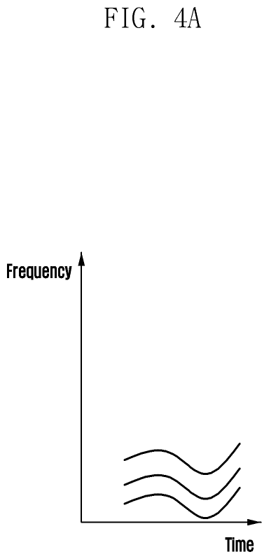

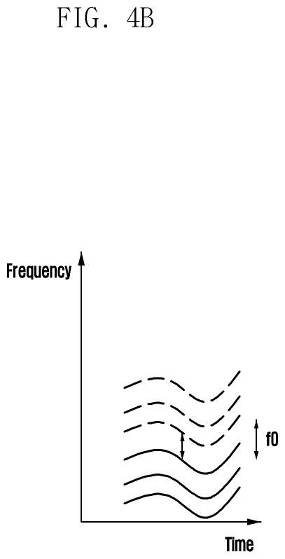

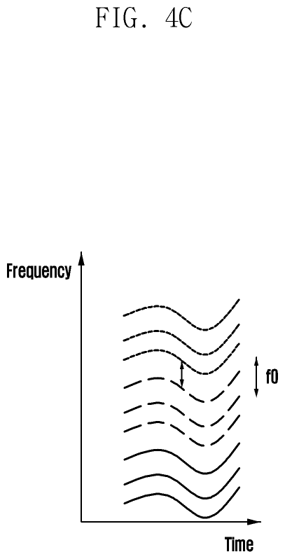

FIGS. 4A, 4B, and 4C are diagrams illustrating an example of extending an effective frequency band of speech according to various embodiments.

FIG. 4A illustrates the frequency components of speech received via a sensor module (e.g., the sensor module 305 of FIG. 3) over time. The frequency components of speech received via sensor module 305 over time may be distributed in a range of 0 to 1 kHz.

According to various embodiments, the f₀ estimation module 346 of FIG. 3 may predict a fundamental frequency (f₀) based on speech information. FIG. 4B and FIG. 4C illustrate examples of frequency components of speech that are extended over time using the fundamental frequency (f₀). FIG. 4B illustrates frequency components of speech that are extended two times over time. FIG. 4C illustrates frequency components of speech that are extended three times over time. The frequency band or set of frequencies where speech is expected to be present is thereby extended

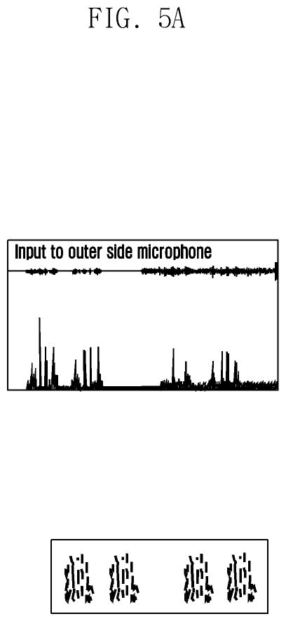

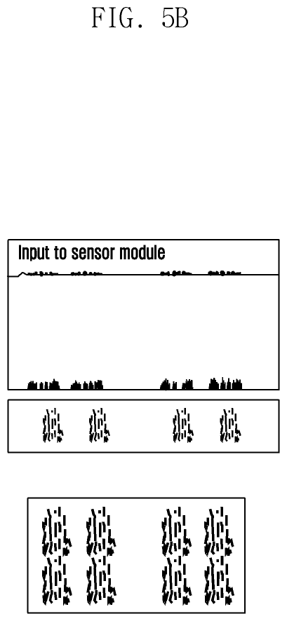

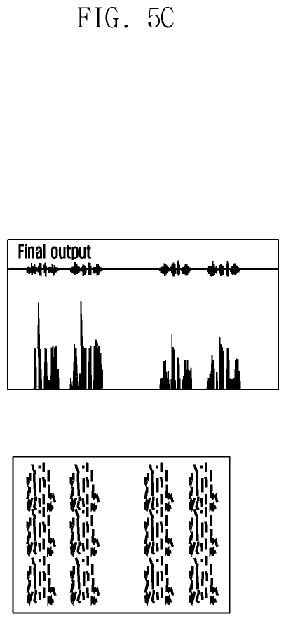

FIGS. 5A, 5B, and 5C are diagrams illustrating an example of a speech signal extracted using a speech presence probability according to various embodiments.

FIG. 5A is a diagram illustrating a signal input via the outer side microphones 310-2 and 310-3. Signals input via the outer side microphones 310-2 and 310-3 may include noise in addition to a user speech signal. According to various embodiments, signals input via the outer side microphones 310-2 and 310-3 may include a speech signal from a counterpart. Referring to FIG. 5A, signals input via the outer side microphones 310-2 and 310-3 may include speech of a user, noise, echo, and the like, and thus various frequency components may be distributed.

FIG. 5B may show a signal input via a sensor module (e.g., the sensor module 305 of FIG. 3). The sensor module 305 may include an acceleration sensor, such that when a user speaks, the vibration of vocal codes of a user may be detected using the acceleration sensor. In FIG. 5A, a part in which the signal of FIG. 5B is absent may be ambient noise or speech of a counterpart, as opposed to speech of a user. Referring to FIG. 5B, a speech presence probability (SPP(f)) of a signal input via the sensor module 305 may be determined for a frequency band including the extended frequency components, as discussed with reference to FIGS. 4A, 4B, and 4C. In this instance, an echo signal band may be excluded.

According to various embodiments, FIG. 5C is an example of detecting a speech signal of a user by determining the probability of presence of speech in a sensor signal received by a sensor module, that is, a speech presence probability (SPP(f)), with respect to an extended frequency band in which speech is expected to be present. Referring to FIG. 5C, it is identified that a speech signal of a user from which noise and echo are cancelled when compared to the signal of FIG. 5A input via the outer side microphones 310-2 and 310-3.

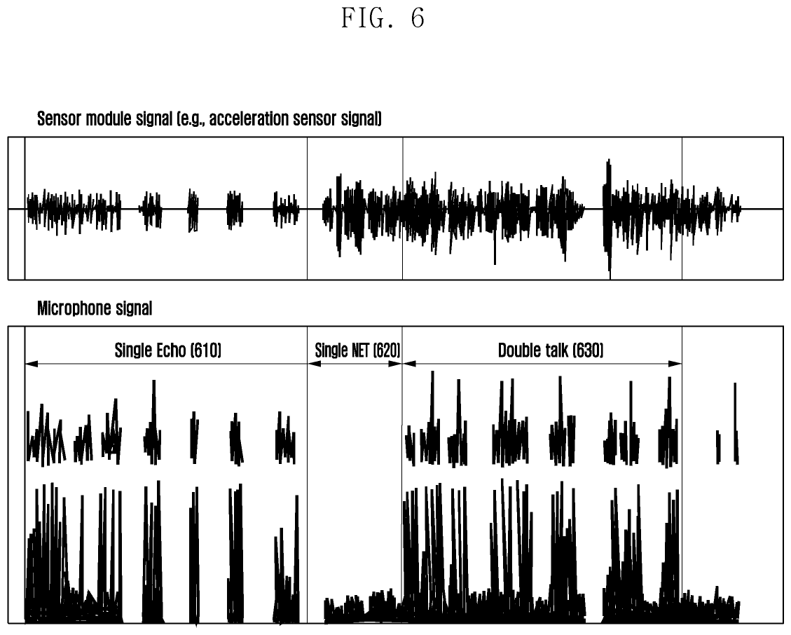

FIG. 6 is a diagram illustrating an example of a signal received via a microphone according to various embodiments.

Referring to FIG. 6, there are various examples of a signal that may be received via a microphone. A first section 610 is an example of a single echo that corresponds to the case in which speech of a counterpart is reproduced via a speaker and is received again by a microphone; this can be termed as “counterpart speech.” A second section 620 is an example of a single NET that corresponds to the case in which a signal only from a user is received; this can be termed as “user speech.” A third section 630 is an example of double-talk that corresponds to the case in which user speech and counterpart speech output via a speaker are both received via a microphone.

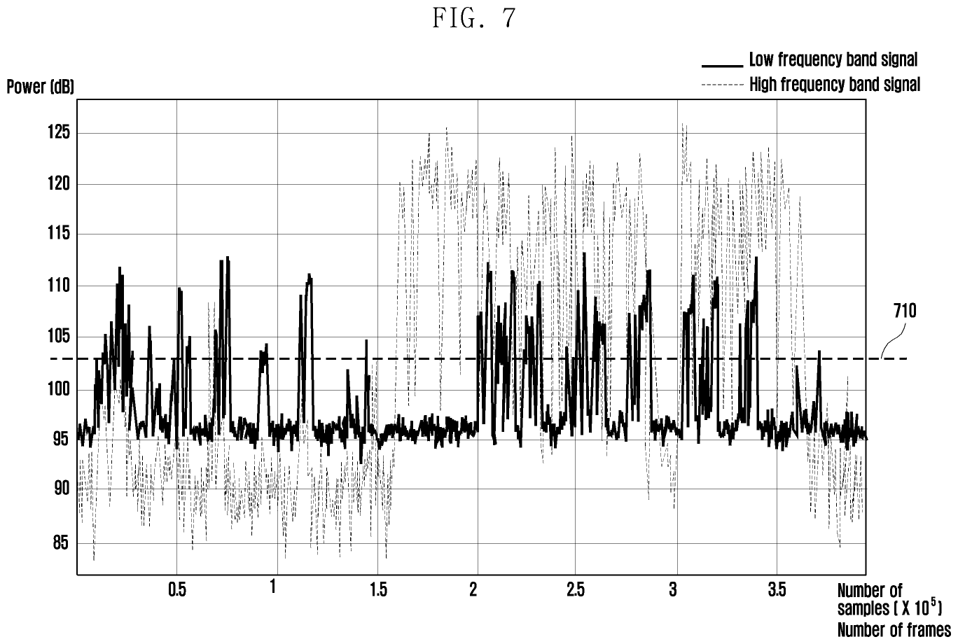

FIG. 7 is a diagram illustrating energy of a signal measured by an acceleration sensor for each of a plurality of frequency bands according to various embodiments.

According to various embodiments, a signal measured using an acceleration sensor may include both a high band frequency and a low band frequency. A signal measured by the acceleration sensor may include noise and thus, if the energy is higher than a predetermined intensity value or threshold 710, it is determined that a signal is present. Referring to FIG. 7, a low frequency band signal may be measured until the number of samples (or frames) reaches 1.5*10\hat{ }5, but it may be determined to be noise since the energy of the signal at this frequency is low.

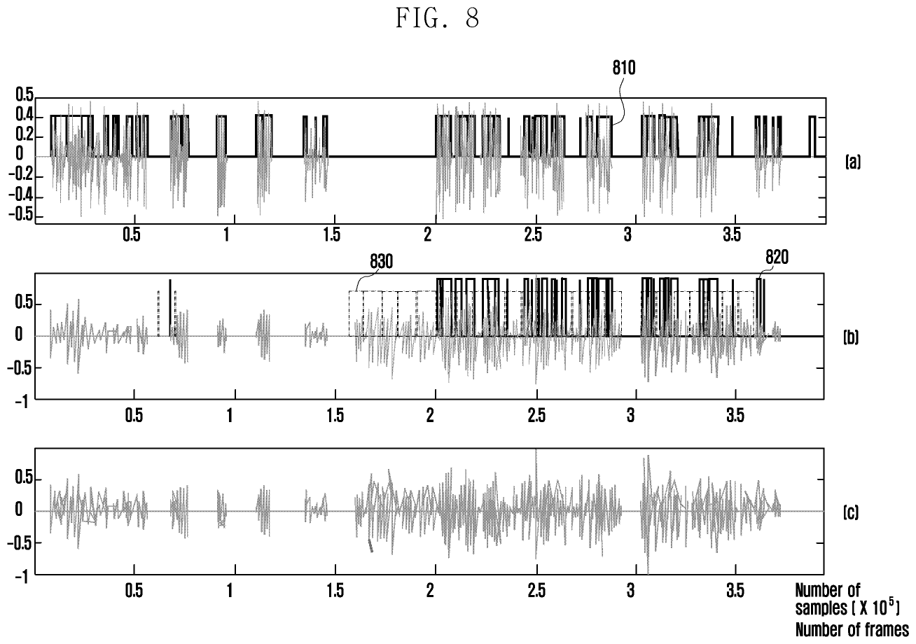

FIG. 8 illustrates diagrams of a result obtained by measuring and processing a signal in an echo environment according to various embodiments.

According to various embodiments, FIG. 8 illustrates a comparison between a signal received via a microphone and a signal measured using an acceleration sensor of FIG. 7. Specifically, diagram (a) of FIG. 8 illustrates a signal (rx reference signal) corresponding to speech of a counterpart that is output from a speaker and input to a microphone and a high frequency band signal 810 of an acceleration sensor. According to various embodiments, a signal corresponding to speech of a counterpart that is output from a speaker and input to a microphone may be a signal of an approximately 6 kHz band. According to various embodiments, a signal in a band of up to an approximately 6 kHz may be detected via the acceleration sensor. If a signal in a band of up to an approximately 6 kHz is detected using the acceleration sensor, an audio input/output device (e.g., the audio input/output device 300 of FIG. 3) may determine the detected signal as a signal corresponding to speech of a counterpart that is output from a speaker and input into a microphone. According to various embodiments, the high frequency band signal 810 (e.g., a 6 kHz band) of an acceleration sensor may be compared with a threshold value and may be expressed as on or off. For example, if the high frequency band signal 810 of the acceleration sensor is higher than the threshold value, the signal may be expressed as on. Otherwise, the signal may be expressed as off. In diagram (a) of FIG. 8, a section in which a signal corresponding to speech of a counterpart that is output from a speaker and input into a microphone is present may be a section in which a high frequency band signal of the acceleration sensor is on. This is because the speaker is incapable of reproducing a low frequency band signal and outputs only a high band frequency.

According to various embodiments, diagram (b) of FIG. 8 illustrates a speech signal input via a microphone, a low frequency band signal 830 of an acceleration sensor, and double-talk 820. Referring to diagram (b) of FIG. 8, a speech signal input via a microphone may include a speech signal of a user and/or a speech signal of a counterpart. According to various embodiments, the low frequency band signal 830 of an acceleration sensor may be compared with a threshold value and may be expressed as on or off. For example, if the low frequency band signal 830 of the acceleration sensor is higher than the threshold value, the signal may be expressed as on. Otherwise, the signal may be expressed as off. A section in which the low frequency band signal of the acceleration sensor is on among the speech signals input via the microphone may be a section in which a speech signal of a user is received. Among the speech signals input via the microphone, double-talk may correspond to a section in which a speech signal of a user and a speech signal of a counterpart are received simultaneously, and other sections may be sections in which a speech signal of a counterpart is received.

According to various embodiments, diagram (c) of FIG. 8 illustrates a signal of an acceleration sensor. The signal of the acceleration sensor of diagram (c) of FIG. 8 may include both a high band frequency and a low band frequency.

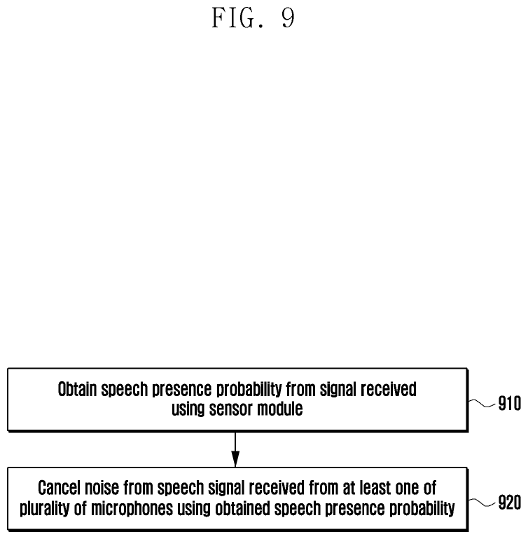

FIG. 9 is a flowchart for processing a speech signal by an audio input/output device according to various embodiments.

According to various embodiments, an audio input/output device (e.g., the audio input/output device 300 of FIG. 3) may obtain a speech presence probability from a sensor signal received using a sensor module (e.g., the sensor module 305 of FIG. 3) in operation 910. According to various embodiments, a speech presence probability (SPP(f)) may be expressed as a ratio of a speech signal to noise. Noise may also include an echo signal. A sensor module may include an acceleration sensor and/or a vibration sensor.

According to various embodiments, the sensor module may be a signal corresponding to the vibration of vocal cords caused by speech of a user. The vibration of vocal cords caused by the speech of the user may be a signal in a frequency band less than or equal to a predetermined frequency. The predetermined frequency may be 1 kHz.

According to various embodiments, the audio input/output device 300 may cancel noise from a speech signal received from at least one of a plurality of microphones (e.g., the microphones 310-1, 310-2, and 310-3 of FIG. 3) using a speech presence probability obtained in operation 920.

According to various embodiments, based on a sensor signal received using the sensor module having a predetermined or higher intensity in a frequency band less than or equal to a predetermined frequency, the audio input/output device 300 may determine the obtained speech presence probability as indicating a probability of the speech signal including speech of a user. The audio input/output device 300 may determine a speech presence probability with respect to an extended frequency band in which speech is expected to be present, and may cancel noise from a speech signal received from at least one of the plurality of microphones.

According to various embodiments, based on a sensor signal received via the sensor module having a predetermined or higher intensity in a frequency band exceeding a predetermined frequency, the audio input/output device 300 may determine the obtained speech presence probability as indicating a probability of the speech signal including speech of a counterpart. Based on a sensor signal received via the sensor module having both a predetermined or higher intensity in a frequency less than or equal to a predetermined frequency and a predetermined or higher intensity in a frequency exceeding the predetermined frequency, the audio input/output device 300 may determine that double-talk occurs.

According to various embodiments, the audio input/output device 300 may further include a communication module, and may thereby transmit a speech signal from which noise is cancelled to an external electronic device. The audio input/output device 300 may receive a speech signal from an external electronic device using a communication module, and may output the same to a speaker (e.g., the speaker 380 of FIG. 3).

According to various embodiments of the disclosure, noise, such as ambient sound, may be cancelled or otherwise accounted for when a microphone is disposed far from the mouth of a user.

Further, according to various embodiments of the disclosure, speech output from a speaker and speech input to a microphone may be distinguished even when a microphone and a speaker are disposed in a relatively short distance.

Further still, according to various embodiments of the disclosure, a high quality of user speech may be received.

An audio input/output device (e.g., the audio input/output device 300 of FIG. 3) according to various embodiments of the disclosure may include a sensor module (e.g., the sensor module 305 of FIG. 3), a speaker (e.g., the speaker 380 of FIG. 3), a plurality of microphones (e.g., the microphones 310-1, 310-2, and 310-3 of FIG. 3), and at least one processor (e.g., the processor 320 of FIG. 3). The at least one processor 320 may be configured to obtain a speech presence probability from a sensor signal received using the sensor module 305, and to cancel, using the obtained speech presence probability, noise from a speech signal received from at least one of the plurality of microphones 310-1, 310-2, and 310-3.

In the audio input/output device 300 according to various embodiments, the speech presence probability may be expressed as a ratio of a speech signal to noise.

In the audio input/output device 300 according to various embodiments of the disclosure, the signal received using the sensor module 305 is a signal corresponding to vibration of vocal cords caused by speech of a user and received.

In the case that the signal received using the sensor module is a signal having a predetermined or higher intensity in a frequency band less than or equal to a predetermined frequency, the at least one processor 320 of the audio input/output device 300 according to various embodiments of the disclosure may be configured to determine the obtained speech presence probability as a speech presence probability of a speech signal of a user.

The at least one processor 320 of the audio input/output device 300 according to various embodiments of the disclosure may be configured to cancel noise from the speech signal received from at least one of the plurality of microphones by extending the speech presence probability with respect to the entire band in which speech is present.

The at least one processor 320 of the audio input/output device 300 according to various embodiments of the disclosure may be configured to cancel noise from the speech signal received from at least one of the plurality of microphones by extending, based on a pitch of the speech signal, the speech presence probability with respect to the entire band in which speech is present.

In the case in which the signal received using the sensor module is a signal having a predetermined or higher intensity in a frequency band exceeding a predetermined frequency, the at least one processor 320 of the audio input/output device 300 according to various embodiments of the disclosure may be configured to determine the obtained speech presence probability as a speech presence probability of a speech signal of a counterpart.

In the case that, as the signal received using the sensor module, both a signal having a predetermined or higher intensity in a frequency band less than or equal to a predetermined frequency and a signal having a predetermined or higher intensity in a frequency band exceeding the predetermined frequency are present, the at least one processor 320 of the audio input/output device 300 according to various embodiments of the disclosure may determine that double-talk occurs.

The sensor module 305 of the audio input/output device 300 according to various embodiments of the disclosure may include an acceleration sensor or a vibration sensor.

The audio input/output device 300 according to various embodiments of the disclosure may further include a communication module, and may transmit a speech signal from which noise is cancelled to an external electronic device.

An operation method of the audio input/output device 300 according to various embodiments of the disclosure may include operation 910 of obtaining a speech presence probability from a signal received using the sensor module 305, and operation 920 of cancelling, using the obtained speech presence probability, noise from a speech signal received from at least one of a plurality of microphones.

In the operation method of the audio input/output device 300 according to various embodiments of the disclosure, the speech presence probability may be expressed as a ratio of a speech signal to noise.

In the operation method of the audio input/output device 300 according to various embodiments of the disclosure, the signal received using the sensor module may be a signal corresponding to vibration of vocal cords caused by speech of a user and received.

The operation method of the audio input/output device 300 according to various embodiments of the disclosure may further include an operation of determining the obtained speech presence probability as a speech presence probability of a speech signal of a user in the case that the signal received using the sensor module is a signal having a predetermined or higher intensity in a frequency band less than or equal to a predetermined frequency.

In the operation method of the audio input/output device 300 according to various embodiments of the disclosure, the operation of cancelling the noise may further include, an operation of cancelling noise from a speech signal received from at least one of the plurality of microphones by extending the speech presence probability with respect to the entire band in which speech is present.

In the operation method of the audio input/output device 300 according to various embodiments of the disclosure, the operation of cancelling the noise may be an operation of cancelling noise from a speech signal received from at least one of the plurality of microphones by extending, based on the pitch of the speech signal, the speech presence probability with respect to the entire band in which speech is present.

The operation method of the audio input/output device 300 according to various embodiments of the disclosure may further include an operation of determining the obtained speech presence probability as a speech presence probability of a speech signal of a counterpart in the case that the signal received using the sensor module is a signal having a predetermined or higher intensity in a frequency band exceeding a predetermined frequency.

In the case that, as the signal received using the sensor module, both a signal having a predetermined or higher intensity in a frequency band less than or equal to a predetermined frequency and a signal having a predetermined or higher intensity in a frequency band exceeding the predetermined frequency are present, the operation method of the audio input/output device 300 according to various embodiments of the disclosure may further include an operation of determining that double-talk occurs.

In the operation method of the audio input/output device 300 according to various embodiments of the disclosure, the signal received using the sensor module may be a signal received using an acceleration sensor or a vibration sensor.

The operation method of the audio input/output device 300 according to various embodiments of the disclosure may further include an operation of transmitting a speech signal from which noise is cancelled to an external electronic device.

In addition, various other embodiments may be possible.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An audio device comprising:
a sensor;
a plurality of microphones; and
at least one processor configured to:
obtain a speech presence probability from a sensor signal received using the sensor; and
cancel, using the obtained speech presence probability, noise from a speech signal received from at least one of the plurality of microphones.

2. The audio device of claim 1, wherein the speech presence probability is expressed as a ratio of speech signal to noise.

3. The audio device of claim 1, wherein the sensor is configured to detect signals corresponding to vibration of vocal cords caused by speech of a user.

4. The audio device of claim 1, wherein the at least one processor is further configured to, based on the sensor signal having a predetermined or higher intensity in a frequency band less than or equal to a predetermined frequency, determine the obtained speech presence probability as indicating a probability of the speech signal including speech of a user.

5. The audio device of claim 4, wherein the at least one processor is further configured to cancel noise from the speech signal by determining the speech presence probability with respect to an extended frequency band in which speech is expected to be present.

6. The audio device of claim 5, wherein the at least one processor is further configured to cancel noise from the speech signal by extending, based on a pitch of the speech signal, a frequency band in which speech is expected to be present, and determining the speech presence probability with respect to the extended frequency band.

7. The audio device of claim 1, wherein the at least one processor is further configured to, based on the sensor signal having a predetermined or higher intensity in a frequency band exceeding a predetermined frequency, determine the obtained speech presence probability as indicating a probability of the speech signal including speech of a counterpart.

8. The audio device of claim 1, wherein the at least one processor is further configured to, based on the sensor signal having both a predetermined or higher intensity in a frequency band less than or equal to a predetermined frequency and a predetermined or higher intensity in a frequency band exceeding the predetermined frequency, determine that double-talk occurs.

9. The audio device of claim 1, wherein the sensor comprises at least one of an acceleration sensor and a vibration sensor.

10. The audio device of claim 1, further comprising a communication module,
wherein the speech signal is transmitted to an external electronic device by the communication module after cancellation of the noise therefrom.

11. An method of operating an audio device, the method comprising:
obtaining a speech presence probability from a sensor signal received using a sensor module; and
cancelling, using the obtained speech presence probability, noise from a speech signal received from at least one of a plurality of microphones.

12. The method of claim 11, wherein the speech presence probability is expressed as a ratio of speech signal to noise.

13. The method of claim 11, wherein the sensor signal corresponds to vibration of vocal cords caused by speech of a user.

14. The method of claim 11, further comprising determining the obtained speech presence probability as indicating a probability of the speech signal including speech of a user, based on the sensor signal having a predetermined or higher intensity in a frequency band less than or equal to a predetermined frequency.

15. The method of claim 14, wherein the cancelling of the noise comprises determining the speech presence probability with respect to an extended frequency band in which speech is expected to be present.
